(19) United States
(12) Patent Application Publication
(10) Pub. No.: US 2022/0349378 A1
(43) Pub. Date: Nov. 3, 2022

(54) ROAD SURFACE ELECTRICAL GENERATOR AND SENSOR

(71) Applicant: RoadSense Advanced Technologies Ltd., Kfar Yona (IL)

(72) Inventors: Baruch Gueta, Kfar Yona (IL); Avi Haskelovich, Rosh Ha'Ayin (IL); Ariel Zukerman, Eilat (IL)

(21) Appl. No.: 17/732,395

(22) Filed: Apr. 28, 2022

Related U.S. Application Data
(60) Provisional application No. 63/181,727, filed on Apr. 29, 2021.

(51) Int. Cl. F03D 3/04; F03D 3/00; F03D 9/11; F03D 9/46

(52) U.S. Cl. CPC F03D 3/0427; F03D 3/005; F03D 9/11; F03D 9/46; F05B 2240/12; F05B 2240/9113; F05B 2250/711; F05B 2250/712

(57) ABSTRACT

Examples of a device for generating electrical power are provided, including a rotor element, a stator element and an electrical generator. The rotor element includes a rotor axis, and the rotor element configured for turning about said rotor axis responsive to an airflow being applied thereto. The stator element is configured for directing the airflow from an outside of the device towards said rotor element. The electrical generator is coupled to the rotor element and is configured for being driven by rotation of the rotor element about the rotor axis to thereby generate electrical power. The device is configured for being affixed with respect to a surface such that the device projects above the surface by an external maximum vertical dimension. The rotor axis is nominally orthogonal to the surface, at least in operation of the device. The external maximum vertical dimension is less than 1 meter.

### TECHNOLOGICAL FIELD

The presently disclosed subject matter relates to electrical sources for powering road sensors.

### BACKGROUND

Road sensors are well known and are configured for providing a range of uses related to traffic.

Such sensors are often powered via electrical cables connected to an electrical power grid.

### GENERAL DESCRIPTION

According to a first aspect of the presently disclosed subject matter, there is provided a device for generating electrical power, comprising a rotor element, a stator element and an electrical generator, wherein said rotor element comprising a rotor axis, the rotor element configured for turning about said rotor axis responsive to an airflow being applied thereto;
said stator element configured for directing the airflow from an outside of the device towards said rotor element;
said electrical generator being coupled to said rotor element and configured for being driven by rotation of the rotor element about the rotor axis to thereby generate electrical power;
wherein the device is configured for being affixed with respect to a surface such that the device projects above the surface by an external maximum vertical dimension;
the rotor axis being nominally orthogonal to the surface, at least in operation of the device; and
wherein said external maximum vertical dimension is less than 1 meter.

For example, said rotor element is in the form of a single-stage rotor configuration, comprising a rotor shaft coaxial with said rotor axis, and a first plurality of first aerodynamic elements each radially positioned with respect to the rotor axis, for example each radially projecting from the rotor axis.

For example, each said first aerodynamic element comprises at least one concave element having a concave surface, a concave element mouth, and a concave peak, wherein the concave peak extends in a first direction from the concave element mouth, and wherein said first direction is nominally orthogonal to said rotor axis. For example, each said concave element has a two-dimensional concave wall defining the concave surface and comprising an upper concave edge and a lower concave edge, and further comprising a nominally flat upper wall joined to said upper edge, and a nominally flat lower wall attached to said lower edge.

For example, each said each said first aerodynamic element comprises a slanted configuration and projecting in a general upward direction from, and joined to, a base. For example, each said first aerodynamic element comprises a flat trailing edge portion including the trailing edge thereof, and a curved leading edge portion including the leading edge, each said aerodynamic element further having a respective aerodynamic element root, at which it is connected to the base, and a longitudinally opposed aerodynamic element tip, wherein the respective curved leading edge portion has generally circular transverse cross-sections, taken orthogonal to a direction parallel to the rotor axis. For example, for each said first aerodynamic element, each respective said transverse cross-section has a respective curvature, and wherein the curvature of the transverse cross-sections increases from the respective aerodynamic element root to the respective aerodynamic element tip.

Additionally or alternatively, for example, said stator element comprises a second plurality of second aerodynamic elements, each said second aerodynamic element projecting from a base plate in a direction generally parallel to the rotor axis. For example, each said second aerodynamic element is in the form of a two-dimensional aerofoil blade, having a uniform aerofoil cross-section along a length of the aerofoil blade, from a lower end of the blade to an upper end of the blade. Additionally or alternatively, for example, said second aerodynamic elements are circumferentially arranged around the rotor axis RA in equally-spaced relationship with respect to one another. Additionally or alternatively, for example, each said two-dimensional aerofoil blade having a respective chord line, wherein each said chord line is set at a chord line angle to a respective radial line, each respective said radial line being an imaginary line projecting laterally along a plane of the respective aerofoil cross-section from the rotor axis and touching the respective trailing edge. For example, said chord line angle is about 60° or about 90°, or said chord line angle is between about 60° to about 90°.

Additionally or alternatively, for example, said aerofoil blades define a plurality of flow passages, each said flow passage being defined between two adjacent said aerofoil blades. For example, each said flow passage has an inlet area, defined at a respective outer plane touching respective leading edges of the respective two adjacent aerofoil blades, and an exit area, defined at a respective inner plane touching respective trailing edges of the respective two adjacent aerofoil blades. For example, said inlet area is larger than said outlet area.

Additionally or alternatively, for example, a ratio of said second plurality to said first plurality is greater than unity. For example, said ratio is any one of the following: 2, 3, 4, 5, 6, 7, 8, 9, 10 or greater than 10.

Additionally or alternatively, for example, the device further comprises an electronics and battery package, configured for managing and storing electrical power output of the electrical generator.

Additionally or alternatively, for example, the device comprises a housing, the housing comprising a first housing part configured for accommodating therein said rotor element and said stator element, and a second housing part configured for accommodating therein said electrical generator. For example, second housing part is configured for being embedded in the surface at least in operation of the device. Additionally or alternatively, for example, said first housing part has a first width dimension, and the second housing part has a second width dimension, wherein the second width dimension is smaller than the first width dimension. For example, the first width dimension is four times larger than the second width dimension. Additionally or alternatively, for example, the second housing part has a third depth dimension, parallel to the rotor axis, the third depth dimension being greater than said second width dimension. For example, the third depth dimension is more than two times larger than the second width dimension.

Additionally or alternatively, for example, said first width dimension is about 20 cm, wherein said second width dimension is about 1.5 cm, and wherein said third depth dimension is between about 4 cm and about 10 am.

Additionally or alternatively, for example, the first housing part comprises a first housing base and a first housing cover, joined together via the stator element.

Additionally or alternatively, for example, the rotor element is rotatably mounted with respect to the first housing part.

Additionally or alternatively, for example, said first housing cover is generally convex.

Additionally or alternatively, for example, said external maximum vertical dimension is defined by a vertical dimension of said first housing part.

Additionally or alternatively, for example, the device is configured for being anchored to the surface, such that only the first housing part projects above the surface.

Additionally or alternatively, for example, the second housing part being configured for being fully embedded in the surface at least in operation of the device, while concurrently the first housing part remains above the surface.

Additionally or alternatively, for example, said external maximum vertical dimension is less than at least one of the following: 0.9 m; 0.8 m; 0.7 m; 0.6 m; 0.5 m; 0.45 m; 0.4 m; 0.35 m; 0.30 m; 0.25 m; 0.20 m; 0.15 m; 0.10 m; 0.05 m; 0.04 m.

Additionally or alternatively, for example, the device is configured for being affixed to a road surface by being embedded in the road surface or in a respective subgrade, or by being attached to the surface of a roadway. Alternatively, for example, the device can be configured for being affixed to railing or barriers provided next to the road surface of the roadway, or for being affixed to a pole next to the road surface of the roadway.

Additionally or alternatively, for example, the device is configured for being affixed to the surface such that the external maximum vertical dimension is such as to enable air flows close to the surface to enter the device via the stator element and cause the rotor element to rotate about the rotor axis, thereby causing the electrical generator to generate electrical power.

According to a second aspect of the presently disclosed subject matter, there is provided a system comprising:
at least one device as defined herein regarding the first aspect of the presently disclosed subject matter;
at least one external electrical load electrically coupled to said at least one device, each said device configured for providing electrical power to said at least one external electrical load.

For example, the external electrical load is in the form of, or includes, an electrical component that consumes electrical power or a portion of an electrical circuit that consumes electrical power.

Additionally or alternatively, for example, at least one said electrical load includes at least one road sensor. For example, at least one said sensor is in the form of an in-roadway sensor or an over-roadway sensor

Additionally or alternatively, for example, at least one said road sensor is any one of an inductive-loop sensor, magnetic detector, magnetometer, imaging cameras, microwave radar devices, laser radar devices, millimeter wave radars, ultrasonic devices, passive infrared sensors, and acoustic sensors.

According to a third aspect of the presently disclosed subject matter, there is provided a powered sensor, comprising:
a device as defined herein regarding the first aspect of the presently disclosed subject matter;
an integral sensor package, accommodated in the device and operatively coupled to the device.

For example, the housing is configured for accommodating the sensor package, and for operatively coupling the sensor package to the electrical generator and/or to the electronics and battery package. For example, the first housing part comprises a chamber for accommodating at least a part of the sensor package.

Additionally or alternatively, for example, part of the sensor package can project to an outside of the housing.

Additionally or alternatively, for example, the sensor package comprises one or more of: an imaging camera, microwave radar devices, laser radar devices, millimeter wave radars, ultrasonic devices, passive infrared sensors, and acoustic sensors.

According to the third aspect of the presently disclosed subject matter, there is also provided a powered sensor, comprising:
a device as defined herein regarding the first aspect of the presently disclosed subject matter;
an integral instrumentation package, accommodated in the device and operatively coupled to the device.

For example, the housing is configured for accommodating the instrumentation package, and for operatively coupling the instrumentation package to the electrical generator and/or to the electronics and battery package. For example, the first housing part comprises a chamber for accommodating at least a part of the instrumentation package.

Additionally or alternatively, for example, part of the instrumentation package can project to an outside of the housing.

Additionally or alternatively, for example, the instrumentation package includes a sensor package. For example, the sensor package comprises one or more of: an imaging camera, microwave radar devices, laser radar devices, millimeter wave radars, ultrasonic devices, passive infrared sensors, and acoustic sensors.

Additionally or alternatively, for example, the instrumentation package includes at least one signaling unit configured for selectively transmitting at least a visual signal. For example, the at least one signaling unit is configured for selectively transmitting said at least a visual signal within a field of view of oncoming drivers. Additionally or alternatively, for example, said at least one signaling unit comprises at least one LED light. For example, said at least one signaling unit is configured for warning drivers of a hazard in real time.

Additionally or alternatively, for example, the instrumentation package is configured for generating and for transmitting sensor data. For example, the instrumentation package is configured for transmitting sensor data via any one of WIFI, LTE, 5G and narrowband networks.

According to a fourth aspect of the presently disclosed subject matter, there is provided a method of providing an electrical power source to an external load, comprising:
(a) providing a device as defined herein regarding the first aspect of the presently disclosed subject matter;
(b) affixing the device with respect to a surface such that no part of the device projects above the surface by more than said external maximum vertical dimension;
(c) electrically coupling the device to the external load;
(d) the device being affixed to the surface at a location sufficiently close to where road vehicles are expected to be travelling, such that the passage of the road vehicles close to the device causes a disturbance in the air which in turn induces an airflow into the device via the respective stator element to thereby turn the rotor element and thereby enable the electrical generator to generate said electrical power and to provide the electrical power to the external load.

According to a fourth aspect of the presently disclosed subject matter, there is provided a method of providing powered sensor, comprising:
providing a powered sensor as defined as defined herein regarding the second aspect of the presently disclosed subject matter;
affixing the powered sensor with respect to a surface such that no part of the device projects above the surface by more than said external maximum vertical dimension;
affixing the powered sensor to the surface at a location sufficiently close to where road vehicles are expected to be travelling, such that the passage of the road vehicles close to the powered sensor causes a disturbance in the air which in turn induces an airflow into the powered sensor via the respective stator element to thereby turn the rotor element and thereby enable the electrical generator to generate said electrical power and to provide the electrical power to the powered sensor.

A feature of at least one example of the presently disclosed subject matter is that a self-contained powered sensor is provided for use in roads and the like, and which is powered by airflows.

A feature of at least one example of the presently disclosed subject matter is that there is provided an independent renewable energy unit, that can operate without the need to be connected to external power source.

Another feature of at least one example of the presently disclosed subject matter is that a self-contained powered sensor is provided that enhances the possibilities of IoT devices in many ecosystems throughout the open space.

Another feature of at least one example of the presently disclosed subject matter is that a smart infrastructure can be created with the combination of radars and sustainable energy.

Another feature of at least one example of the presently disclosed subject matter is that smart roads can be provided, reducing risk and/or incidence of vehicle accidents, and/or that can improve road planning, and/or that can assist the driver and increase survival rate after a crash.

Another feature of at least one example of the presently disclosed subject matter is that a cost-effective solution can be provided for roadway sensors and the like, as compared with existing solutions like CCTV's or devices connected to the power grid.

### BRIEF DESCRIPTION OF THE DRAWINGS

In order to better understand the subject matter that is disclosed herein and to exemplify how it may be carried out in practice, examples will now be described, by way of non-limiting example only, with reference to the accompanying drawings, in which:

FIG. 1 is a cross-sectional side view of a device according to a first example of the presently disclose subject matter.

FIG. 2 is a side view of the example of FIG. 1, affixed to a surface.

FIG. 3 is an isometric view of an example of a rotor element and a stator element of the example of the device of FIG. 1.

FIG. 4 is an isometric view of part of the rotor element of the example of FIG. 3.

FIG. 5 is a top view of an alternative variation of the example of the rotor element of the example of the device of FIG. 1.

FIG. 6 is an isometric view of another alternative variation of the example of the rotor element of the example of the device of FIG. 1.

FIG. 7 is an isometric view of another alternative variation of the example of the rotor element of the example of the device of FIG. 1.

FIG. 8 is an isometric view of another alternative variation of the example of the rotor element of the example of the device of FIG. 1.

FIG. 9 is an isometric view of another alternative variation of the example of the rotor element of the example of the device of FIG. 1.

FIG. 10 is an isometric view of another alternative variation of the example of the rotor element of the example of the device of FIG. 1.

FIG. 11 is an isometric view of the stator element of the example of FIG. 3.

FIG. 12 is a schematic illustration of a system according to an example of the presently disclose subject matter and including a device according to the example of FIG. 1.

FIG. 13 is a cross-sectional side view of a device according to an alternative variation of the example of FIG. 1, in the form of a powered sensor.

### DETAILED DESCRIPTION

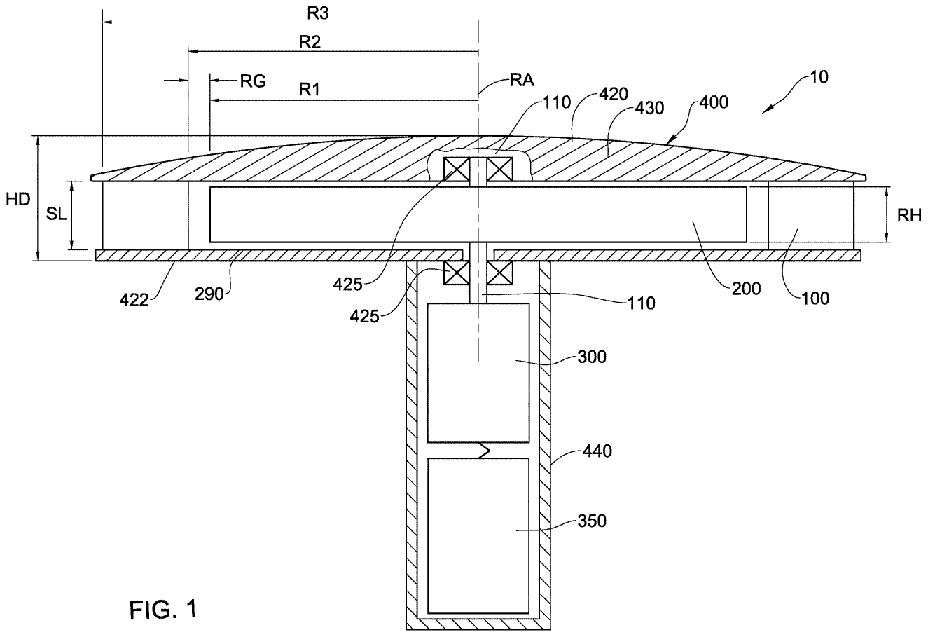

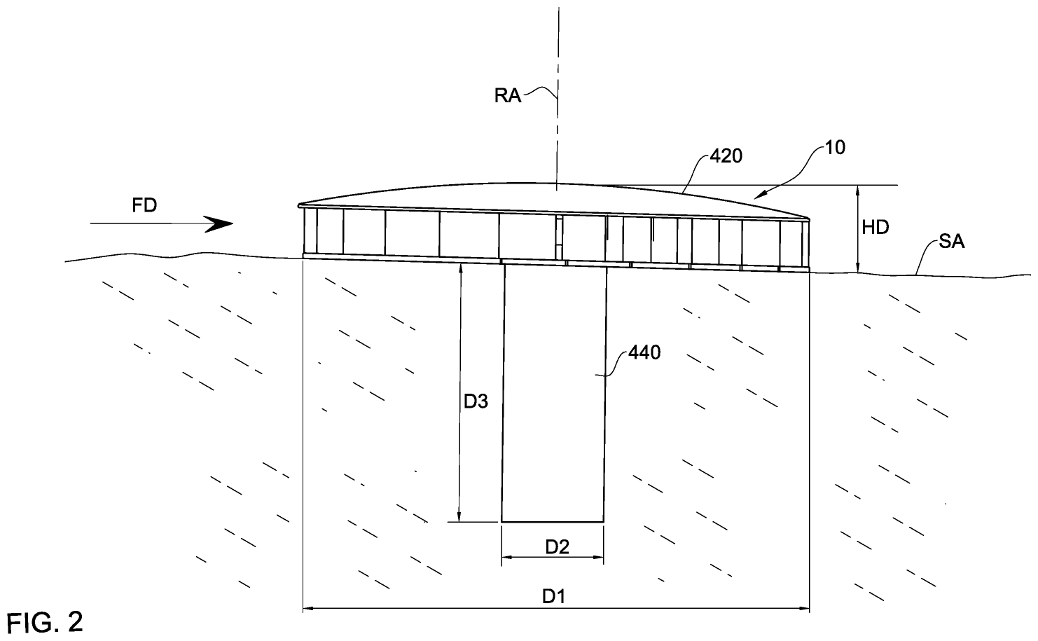

Referring to FIGS. 1 and 2, a device for generating electrical power according to a first example of the presently disclosed subject matter, generally designated with reference numeral 10, comprises a rotor element 100, a stator element 200, and an electrical generator 300.

The rotor element 100 comprises a rotor axis RA, which, at least in this example and at least in operation of the device 10, nominally orthogonal to the surface SA on which the device 10 is to be affixed.

The rotor element 100 is configured for turning about the rotor axis RA responsive to an external airflow being directed towards the rotor element in a flow direction FD generally orthogonal to the rotor axis RA, and typically parallel to the surface SA.

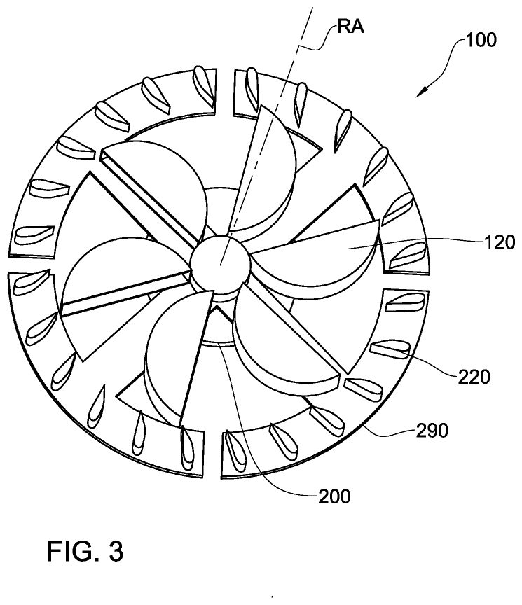

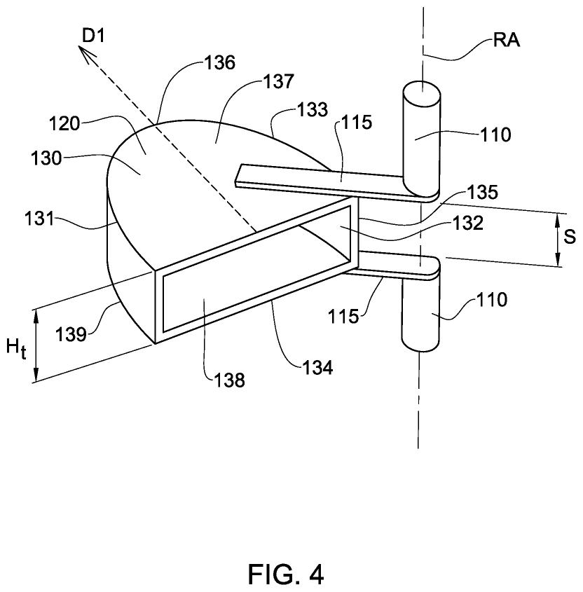

In at least this example, and referring also to FIGS. 3 and 4, the rotor element 100 is in the form of a single-stage rotor configuration, comprising a rotor shaft 110 coaxial with said rotor axis RA, and a first plurality of first aerodynamic elements 120 radially projecting from the rotor shaft 110. In at least this example, and referring in particular to FIG. 4, each first aerodynamic element 120 comprises at least one concave element 130 having a concave surface 132, a concave element mouth 134, and a peak 136, wherein the peak 136 extends in a first direction D1 from the concave element mouth 134. The first direction D1 is nominally orthogonal to the rotor axis RA.

Each concave surface 132 has concave cross-sections on planes extending along a direction parallel to the rotor axis RA.

Furthermore, each concave element 130 has a two-dimensional concave wall 133 defining the concave surface 132, the concave wall 133 further comprising an upper concave edge 131 and a lower concave edge 139. Each concave element 130 further comprises a nominally flat upper wall 137 joined to the upper edge 131, and a nominally flat lower wall 138 attached to the lower edge 139.

Thus, each concave element 130 is open at the respective concave element mouth 134, and defines therein an open concave volume bounded by concave wall 133, upper wall 137, and lower wall 138, and open at the respective concave element mouth 134.

Each concave element 130 is mounted to the shaft 110 via radial connector elements 115.

In at least this example, the shaft 110 comprises an upper shaft element 112 and a coaxial lower shaft element 114, vertically separated by a spacing S to thereby provide a free space between the inboard part 135 of the respective concave elements 130 closest to the rotor axis RA. For example, spacing S is provided by the height dimension Ht of the concave element 130.

While in this example the rotor element 100 comprises six first aerodynamic elements 120, in alternative variations of this example the respective rotor element can have 2, 3, 4, 5 first aerodynamic elements 120, or more than six first aerodynamic elements 120, for example 7, 8, 9, 10, 11, 12 or more than 12 first aerodynamic elements 120.

Referring again to FIG. 1, when viewed in a direction parallel to the rotor axis RA, the rotor element 100, in particular the first aerodynamic elements 120, in at least this example the plurality of concave elements 130, circumscribe a circle of maximum radius R1 when the rotor element 100 rotates about rotor axis RA.

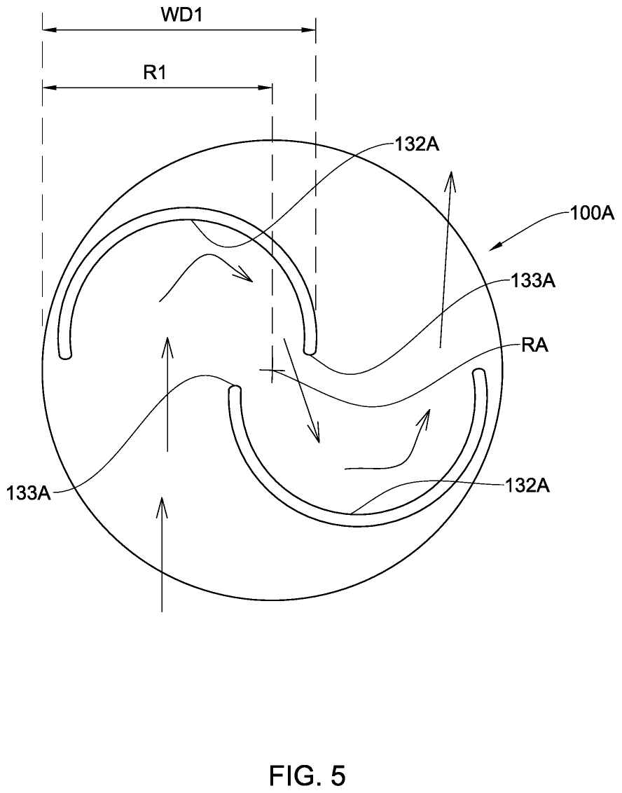

In at least one alternative variation of this example, and referring to FIG. 5, the respective rotor element, designated with reference numeral 100A, is instead in the form of a Savonius wind turbine, comprising a plurality of curved aerodynamic elements 130A, each having a width dimension WD1 larger than the respective maximum radius R1 of the rotor element 100A. Thus, the inner edges 133A of the respective curved aerodynamic elements 130A overlap with, or are radially spaced from one another, with respect to the rotor axis RA, such to enable part of an incident airflow impinging on the concave surface 132A of one curved aerodynamic element 130A to be directed directly towards the concave surface 132A of another curved aerodynamic element 130A. In this example, the inner edges 133A are nominally parallel to the rotor axis RA. In yet another alternative variation of this example, the respective rotor element is specifically in the form of a helical Savonius wind turbine.

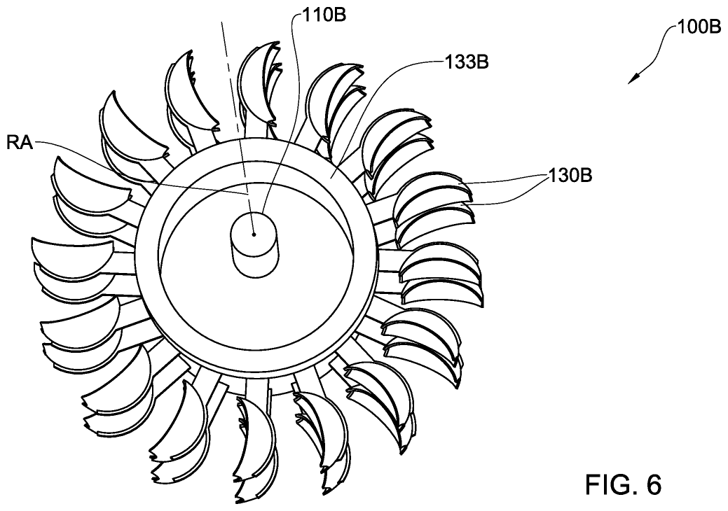

In at least one other alternative variation of this example, and referring to FIG. 6, the respective rotor element, designated with reference numeral 100B, is instead in the form of a Pelton wheel, comprising a plurality of bucket-shaped aerodynamic elements 130B are provided at the rim of a carrier wheel element 133B that is coaxial with and fixed to the rotor shaft 110B. The bucket-shaped aerodynamic elements 130B are configured for causing an incident airflow to turn around by 180° nominally, thereby imparting a force to the rotor element 100B, and causing this to rotate about the rotor axis RA.

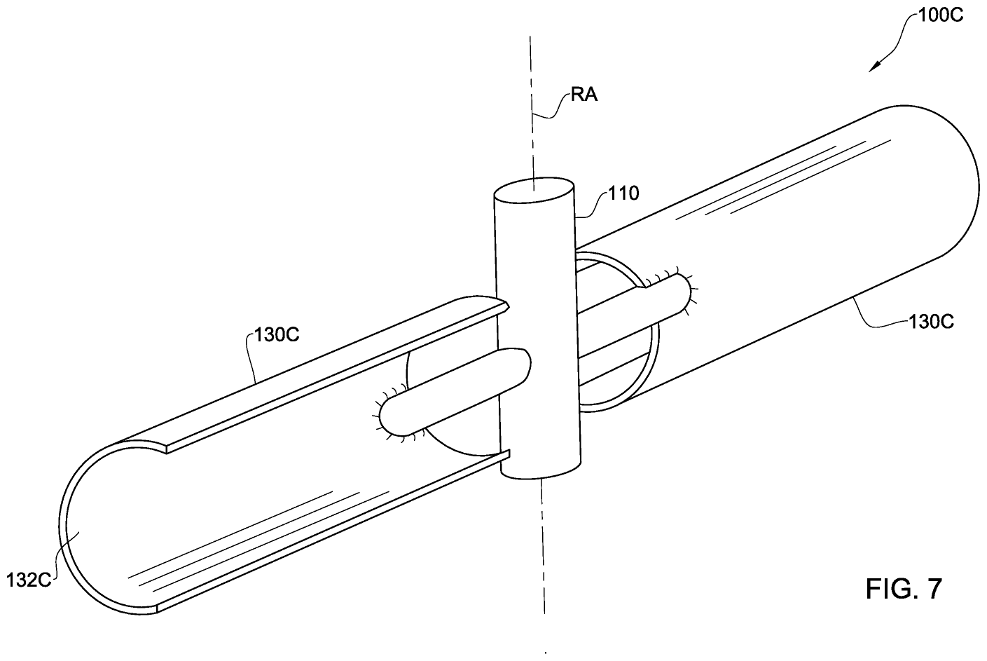

In at least one other alternative variation of this example, and referring to FIG. 7, the respective rotor element, designated with reference numeral 100C, comprises a plurality of concave aerodynamic elements 130C radially connected to the rotor shaft 110C. Each concave aerodynamic element 130C has a two-dimensional concave surface 132C configured for facing the incident airflow. Each concave surface 132C has concave cross-sections on planes extending along a radial direction from the rotor axis RA.

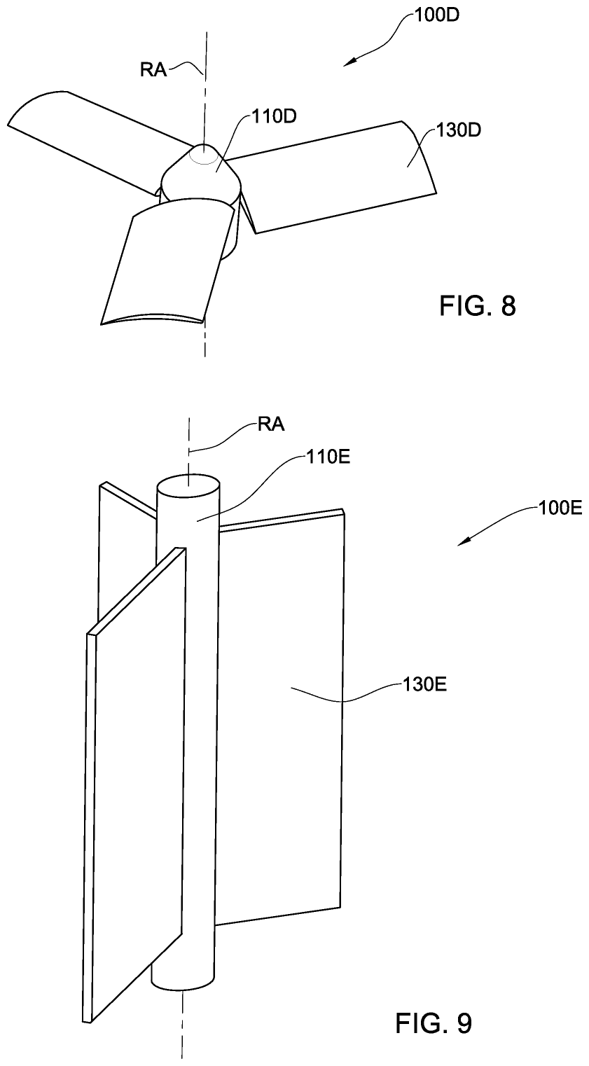

In at least one other alternative variation of this example, and referring to FIG. 8, the respective rotor element, designated with reference numeral 100D, is instead in the form of a propeller rotor, comprising a plurality of aerodynamic elements 130D in the form of aerodynamic blades radially projecting from the rotor shaft 110D. The blade-shaped aerodynamic elements 130D have aerofoil-shaped cross-sections, and are configured for turning the rotor element 100D about the rotor axis RA when subjected to an airflow.

In at least one other alternative variation of this example, and referring to FIG. 9, the respective rotor element, designated with reference numeral 100E, is instead in the form of a paddlewheel, comprising a plurality of paddle elements 130E in the form of flat plates radially projecting from the rotor shaft 110E. The paddle elements 130E in the form of flat plates are configured for turning the rotor element 100E about the rotor axis RA when subjected to an airflow.

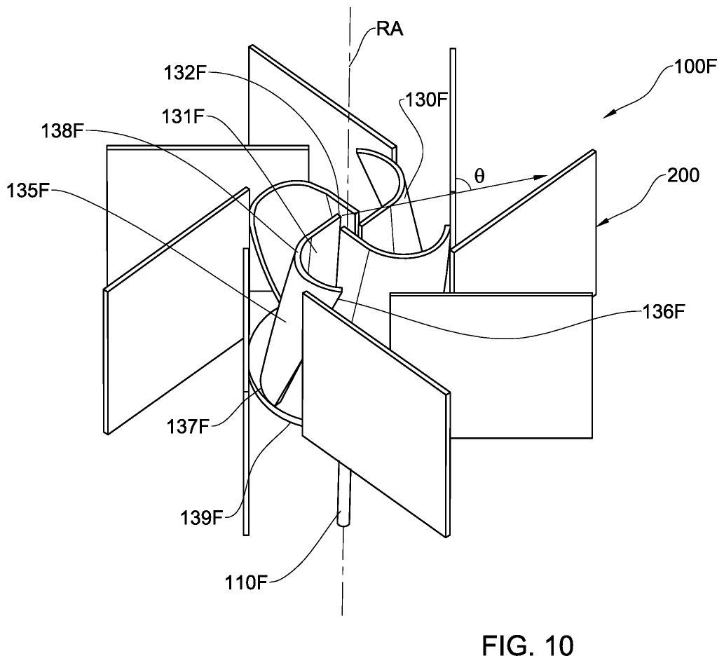

In at least one other alternative variation of this example, and referring to FIG. 10, the respective rotor element, designated with reference numeral 100F, instead comprises a plurality of slanted aerodynamic elements 130F projecting in a general upward direction from, and joined to, a base 139F. The base 139F is in the form of a disc, which is connected to and spins together with the with aerodynamic elements 130F and the respective rotor shaft 110F as a single unit about the rotor axis RA. Each aerodynamic element 130F comprises a flat trailing edge portion 131F including the trailing edge 132F thereof, and a curved leading edge portion 135F including the leading edge 136F. Each aerodynamic element 130F has a respective aerodynamic element root 137F, at which it is connected to the base 139F, and a longitudinally opposed aerodynamic element tip 138F, which at least in this example is free. The trailing edge 132F is nominally parallel to the rotor axis RA and displaced laterally with respect thereto such as to enable part of an incident airflow entering one aerodynamic element 130F via the leading edge 136F thereof, exits the aerodynamic element via the trailing edge 136F thereof and is directed directly towards the trailing edge 132F of another said aerodynamic element 130F to then exit via the leading edge 136F of this second curved aerodynamic element 130F. Thus, the aerodynamic elements 130F have a width dimension larger than the respective maximum radius R1 of the rotor element 100F. The curved leading edge portion 135F has generally circular transverse cross-sections, taken orthogonal to a direction parallel to the rotor axis RA. Each such transverse cross-section has a respective curvature. In this example, the curvature of the transverse cross-sections increases from the respective aerodynamic element root 137F to the respective aerodynamic element tip 138F, and thus provides a slanted curved surface with respect to the rotor axis RA.

Referring again to FIG. 3, the stator element 200 configured for directing the airflow from an outside of the device 10 towards the rotor element 100, to thereby facilitate rotation of the rotor element 100 about the rotor axis RA. It is to be noted that in respective alternative variations of this example, the stator element 200 is configured for directing the airflow from an outside of the device 10 towards the respective rotor element, for example according to any one of the examples of the rotor element 100A, 100B, 100C, 100D, 100E, 100F of FIGS. 4 to 10, mutatis mutandis, to thereby facilitate rotation of the respective rotor element about the rotor axis RA.

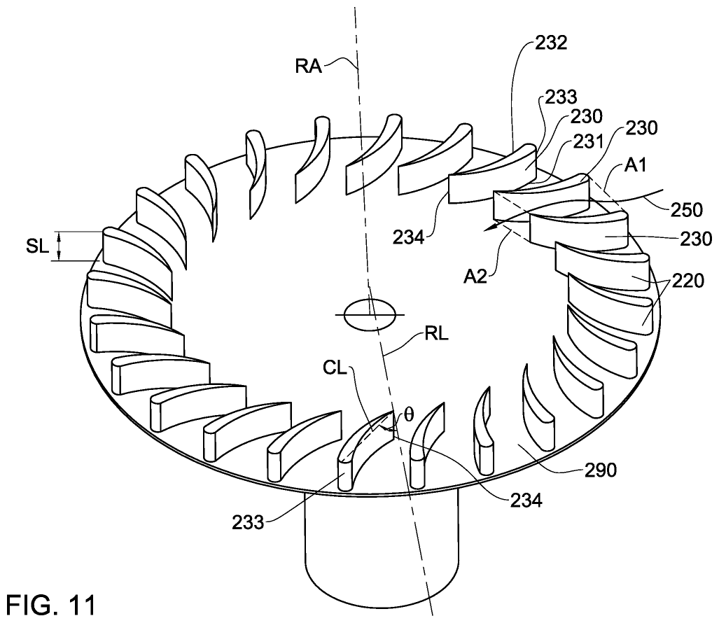

Referring also to FIG. 11, the stator element 200 comprises a second plurality of second aerodynamic elements 220. Each second aerodynamic element 220 projects from a base plate 290 in a direction generally parallel to the rotor axis RA. Each second aerodynamic element 220 is connected to base plate 290, either integrally, or alternatively by separately manufacturing the base plate 290 and the second aerodynamic elements 220, and then affixing the second aerodynamic elements 220 to the base plate 290.

In at least this example, each second aerodynamic element 220 is in the form of a two-dimensional aerofoil blade 230, having a uniform aerofoil cross-section along the length of the aerofoil blade 230, from a lower end 231 of the blade 230 to an upper end 232 of the blade 230.

Thus, for each aerofoil blade 230, each respective aerofoil cross-section lies on a plane orthogonal to the rotor axis RA, and each such aerofoil cross-section has a chord line CL, joining the respective leading edge 233 to the respective trailing edge 234.

The length dimension SL between the lower end 231 of the blade 230 and the upper end 232 of each one of the blades 230 is parallel to the rotational axis RA of the rotor element 100.

In at least this example, the respective leading edge 233 and the respective trailing edge 234 of each one of the blades 230 is parallel to the rotational axis RA of the rotor element 100.

The second aerodynamic elements 220, in at least this example the plurality of aerofoil blades 230, are circumferentially arranged around the rotor axis RA in equally-spaced relationship with respect to one another.

In at least this example, the stator element 200 comprises 24 second aerodynamic elements 220, but in alternative variations of this example the stator element 200 can include more than, or less than, 24 second aerodynamic elements 220.

According to an aspect of the presently disclosed subject matter, the number of second aerodynamic elements 220 of the stator element 200 is not the same as the number of the respective first aerodynamic elements 120 of the rotor element 100.

In at least this example, the ratio of second aerodynamic elements 220 to first aerodynamic elements 120 is greater than unity. In other words, the number of second aerodynamic elements 220 of the stator element 200 is greater than the number of the respective first aerodynamic elements 120 of the rotor element 100.

In at least this example, the ratio of second aerodynamic elements 220 to first aerodynamic elements 120 is 4:1. In alternative variations of this example, the ratio of second aerodynamic elements 220 to first aerodynamic elements 120 can be less than 4, for example 2 or 3, or can be greater than 4, for example 5, 6, 7, 8, 9, 10 or greater than 10.

In at least this example, and referring again to FIG. 1, the length dimension SL of the second aerodynamic elements 220, i.e., of the aerofoil blades 230, is nominally the same or a little less than the height dimension RH of the rotor element 100, in particular of the first aerodynamic elements 120, more in particular of the corresponding concave elements 130. When viewed in a direction parallel to the rotor axis RA, the stator element 200, in particular the second aerodynamic elements 220, in at least this example the plurality of aerofoil blades 230, are located in an annular volume, having an inner radius R2 and outer radius R3, and height SL.

Referring again to FIG. 1, inner radius R2 is greater than radius R1 of the rotor element 100, by a radial gap RG. Such a gap can be chosen as close as possible to radius R1, for example in order to minimize or prevent energy loss. For example, the gap RG can be in the range of between about 1% and 5% of radius R1.

The chord line CL of the aerofoil cross-sections of each aerofoil blade 230 is set at an angle θ to a radial line RL. Each respective radial line RA is an imaginary line projecting laterally along the plane of the respective aerofoil cross-section from the rotor axis RA and touching the respective trailing edge 231.

In at least this example, angle θ is set at about 60°. In the example of FIG. 10, angle θ is set at about 90°. In alternative variations of this example, angle θ can instead be any suitable angle between 30° and 90°, or between 60° and 90°, for example.

The plurality of second aerodynamic elements 220, in particular the corresponding plurality of the aerofoil blades 230, define a plurality of flow passages 250, each flow passage 250 being between two adjacent aerofoil blades 230.

Each such flow passage 250 has an inlet area A1, defined at a respective outer plane touching the leading edges 231 of the respective two adjacent aerofoil blades 230, and an exit area A2 defined at a respective inner plane touching the trailing edges 232 of the respective two adjacent aerofoil blades 230.

In at least this example, the inlet area A1 is larger than the outlet area A2, thereby accelerating any airflow entering the stator element 200.

An alternative variation of the stator element 200 is illustrated in FIG. 10, in which the respective second aerodynamic elements 220 are in the form of flat plates. In this example, the angle θ is set at about 90°.

Referring again to FIG. 1, the electrical generator 300 is coupled to the rotor element 100, and is configured for being driven by rotation of the rotor element 100 about the rotor axis RA, in response to the rotor element 100 being acted upon by an external airstream, to thereby generate electrical power.

In at least this example, the device 10 further comprises an electronics and battery package 350, configured for managing and storing the electrical power output of the electrical generator 300. The electronics and battery package 350 is electrically coupled to the electrical generator 300.

Referring again to FIGS. 1 and 2, the device 10 further comprises a housing 400, comprising a first housing part 420 and a second housing part 440.

The first housing part 420 is configured for accommodating therein said rotor element 100 and said stator element 200, and for enabling the rotor element 100 to turn about rotor axis RA while the stator element 200 remains static.

The first housing part 420 comprises a first housing base 422 and a first housing cover 430. In at least this example, the first housing base 422 has a nominally flat underside.

In at least this example, the first housing base 422 comprises the base plate 290 or is in the form of a base plate 290.

The first housing cover 430 is spaced from the first housing base 422 by length dimension SL, via the plurality of second aerodynamic elements 220, in particular the corresponding plurality of the aerofoil blades 230. In at least this example, each second aerodynamic element 220, in particular each corresponding aerofoil blade 230, is connected at a lower end 231 thereof to the base plate 290 and thus to the first housing base 422, and at the upper end 232 thereof to an underside of the first housing cover 430.

The rotor element 100 is rotatably mounted with respect to the first housing part 420, and the shaft 110 is thus mounted to bearings 425 provided in the first housing base 422 and the first housing cover 430.

In at least this example, the first housing cover 430 is generally dome-shaped, i.e., generally convex, having a generally large curvature, and having a generally smooth convex surface. Without being bound to theory, inventors consider that such a shape for the first housing cover 430 can be beneficial in minimizing accumulation of rain or other atmospheric particles on the first housing cover 430. Furthermore, and again without being bound to theory, inventors consider that such a shape for the first housing cover 430 can be beneficial in enabling road debris having a vertical dimension greater than length dimension SL to be deflected over the first housing cover 430 and away from the device 10, when in collision with the device 10 at the level of the surface SA.

Referring in particular to FIG. 1, in at least this example, according to an aspect of the presently disclosed subject matter, the first housing part 420 has an external maximum vertical dimension HD that is less than 1 m. More in particular, the external maximum vertical dimension HD that is less than at least one of the following: 0.9 m; 0.8 m; 0.7 m; 0.6 m; 0.5 m; 0.45 m; 0.4 m; 0.35 m; 0.30 m; 0.25 m; 0.20 m; 0.15 m; 0.10 m; 0.05 m; 0.04 m.

The second housing part 440 is configured for accommodating therein the electrical generator 300, and at least in this example, also the electronics and battery package 350.

In at least this example, and referring in particular to FIG. 2, the device 10 is configured for being anchored to a surface SA of a road or the like, such that only the first housing part 420 projects above the surface SA, i.e., such that the device 10 only projects above the surface SA by the aforesaid external maximum vertical dimension HD.

In particular, and in at least this example, the second housing part 440 is configured for being fully embedded in the surface at least in operation of the device 10, while concurrently the first housing part 420 remains above the surface SA.

For this purpose, and at least in this example, the first housing part has a first width dimension D1 (nominally orthogonal to the rotor axis RA), and the second housing part has a second width dimension D2 (nominally orthogonal to the rotor axis RA). In at least this example, the first width dimension D1 is larger than the second width dimension D2. For example, the first width dimension D1 is at least four times larger than the second width dimension D2.

Furthermore, the second housing part has a third depth dimensions (parallel to the rotor axis RA) that is greater than the aforesaid second width dimension D2. For example, the third depth dimension D3 is more than two times larger than the second width dimension D2.

In at least one example, D1 is about 20 cm or more, D2 is for example 1.5 cm, and D3 is for example 10 cm, and HD can be between 4 cm to 10 cm, for example.

Optionally, the second housing part 440 can include lateral projections (not shown) to further anchor the device 10 in the road surface.

Further optionally or alternatively, the first housing part 220 can include vertical projections (not shown) that can dig into the surface SA, and thus further anchor the device 10 in the road surface.

Furthermore, the device 10 is configured as an in-roadway device, i.e., configured for being affixed to a surface, for example embedded therein and/or attached to the surface. In particular, while at least in this example, the device 10 is configured for being affixed with respect to a road surface, in alternative variations of this example the device 10 is configured for being affixed to a railway line surface, for example.

Thus, in at least this example, the device 10 is configured for being affixed to a road surface by being embedded in the road surface (also referred to herein as the pavement) or in the subgrade, which is commonly the native material underneath a constructed road. In at least some alternative variations of this example, the deice 10 is configured for being attached to the surface of a roadway, for example using tape, screws, or adhesive.

Thus, it is apparent the device 10 is configured for being affixed to a surface SA such that any part of the device 10, is projecting above the surface by a maximum projection dimension HD. Furthermore, according to this aspect of the presently disclosed subject matter, the external maximum vertical dimension HD is such as to enable air flows close to the surface SA to enter the device 10 via the stator element 200 and cause the rotor element to rotate about the rotor axis RA, thereby causing the electrical generator 300 to generate electrical power. For example, such an electrical generator 300 can generate about 0.5 Watt when the device 10 is affixed to a surface close to a busy highway, for example.

Such air flows can be intermittent or semi-continuous or continuous, depending on atmospheric conditions as well as traffic conditions in proximity to the device 10, for example. For example, the device 10 can be located close to where road vehicles are travelling, such that the passage of the road vehicles close to the device 10 causes each time a disturbance in the air which in turn induces an airflow into the device 10 via the stator element 200 to thereby turn the rotor element 100.

The electronics and battery package 350 can regulate, control and store such electrical power generated by the electrical generator 300.

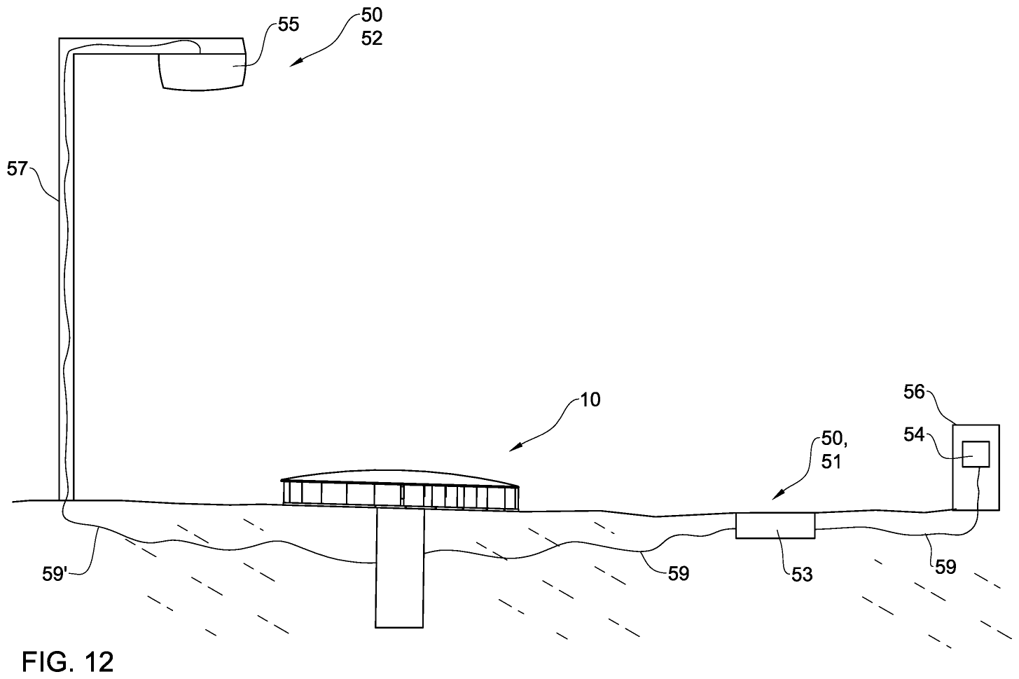

In at least this example, and referring to FIG. 12, the device 10 is configured for providing electrical power to an external electrical load 50. Thus, according to another aspect of the presently disclosed subject matter there is provided a system comprising at least one such device 100 operatively connected to at least one such external electrical load 50.

Herein, such an electrical load 50 can be in the form of, or can include, an electrical component that consumes electrical power or a portion of an electrical circuit that consumes electrical power. At least part of such electrical power is provided by device 10 or a plurality of such devices 10, according to some aspects of the presently disclose subject matter.

According to at least one aspect of the presently disclosed subject matter, in at least one example, such an electrical load includes at least one road sensor 51, in particular in the form of an in-roadway sensor 53. As is known in the art, such in-roadway sensors 53 can be embedded in the road surface (also referred to herein as the pavement) or in the subgrade, which is commonly the native material underneath a constructed road. Alternatively, such in-roadway sensors 53 can be attached to the surface of a roadway, for example using tape, screws, or adhesive.

For example, such an in-roadway sensor 53 can include an inductive-loop sensor, typically comprising loops of wire embedded into sawcuts that are formed in the road surface. Such an example of an in-roadway sensor 53 has detection areas associated therewith, comprising the wire loops, and operates to generate an electrical signal responsive to a vehicle (or any other conductive metal object) passing over or stopped over the detection area (which causes the inductance of the wire loops to decrease). The electrical signal is transmitted, typically via suitable wiring, to curbside junction box (also commonly known as a pull-box) to an electronics unit 54 that can be housed in a controller cabinet 56. In this example, the device 10 does not provide electrical power to the in-roadway sensor 53 itself, but rather to electronics unit 54 and/or to the controller cabinet 56, and thus one or more devices 10 are correspondingly operatively connected to electronics unit 54 and/or to the controller cabinet 56, for example via cables 59.

In another example, the in-roadway sensor 53 can comprise a magnetic detector or a magnetometer, which can be placed underneath the road surface, or underneath a bridge, for example. As is known in the art, such magnetic detectors or magnetometers are configured to detect changes in the Earth's magnetic field responsive to a vehicle (or any other object comprising ferrous material) passing over or stopped over the corresponding detection area of the in-roadway sensor, and for generating corresponding electrical signals. In operation such an in-roadway sensor 53 is also configured for transmitting the signals to the electronics unit 54. In this example, the device 10 can provide electrical power to the in-roadway sensor 53 itself, and/or to electronics unit 54, and/or to the controller cabinet 56. Thus, one or more devices 10 are correspondingly operatively connected to the in-roadway sensor 53, and/or to the electronics unit 54 and/or to the controller cabinet 56, for example via cables 59.

The electronics unit 54 can be configured for analyzing the signal, generated by an in-roadway sensor 53 that includes an inductive-loop sensor, or generated by an in-roadway sensor 53 that can comprise a magnetic detector or a magnetometer, and for determining whether the signal corresponds to a vehicle passing over the detection area or to a vehicle standing over the detection area, and can be further configured for sending an appropriate signal to a central control, remote from the in-roadway sensor 53. In this manner, the central controller can be kept updated regarding the movement of vehicles over the respective detection area, and thus the respective portion of a highway of which the road surface forms part.

In at least one other example, such an electrical load is also in the form of a road sensor 52, however in the form of an over-roadway sensor 55. As is known in the art, such over-roadway sensors 55 can be mounted above the roadside or alongside the roadside, for example on a pole or other overhanging support 57.

For example, such an over-roadway sensor 55 can include imaging cameras mounted above the road surface, for example via poles or overhanging support structures. Such imaging cameras operate to provide image data corresponding to respective portion of a highway of which the road surface forms part, and for transmitting the image data to the central control, either via a wire connection or a wireless connection (not shown). For example, such imaging cameras can be configured for transmitting the sensor data. In the form of image data for example, to the central control, via any one of WIFI, LTE, 5G and narrowband networks.

In this example, the device 10 can provide electrical power to the over-roadway sensor 55. Thus, one or more devices 10 are correspondingly operatively connected to the over-roadway sensor 55, for example via cables 59′.

In yet other examples, the sensors 52 can include one or more of: microwave radar devices, laser radar devices, millimeter wave radars, ultrasonic devices, passive infrared sensors, and acoustic sensors. Such sensors 52 can be mounted in an over-roadway manner, i.e., alongside or over the road surface and vertically spaced from the road surface typically by more than one meter, or can be mounted in an in-roadway manner, i.e., embedded in or attached to the road surface. In any case, such sensors operate to provide corresponding sensor data, corresponding to respective portion of a highway of which the road surface forms part, and for transmitting the data to the central control, either via a wire connection or a wireless connection. In such examples, the device 10 can provide electrical power to the respective sensor 52. Thus, one or more devices 10 are correspondingly operatively connected to the sensor 52.

For example, such devices 10 can be configured for transmitting any sensor data, for example to the central control, via any one of WIFI, LTE, 5G and narrowband networks.

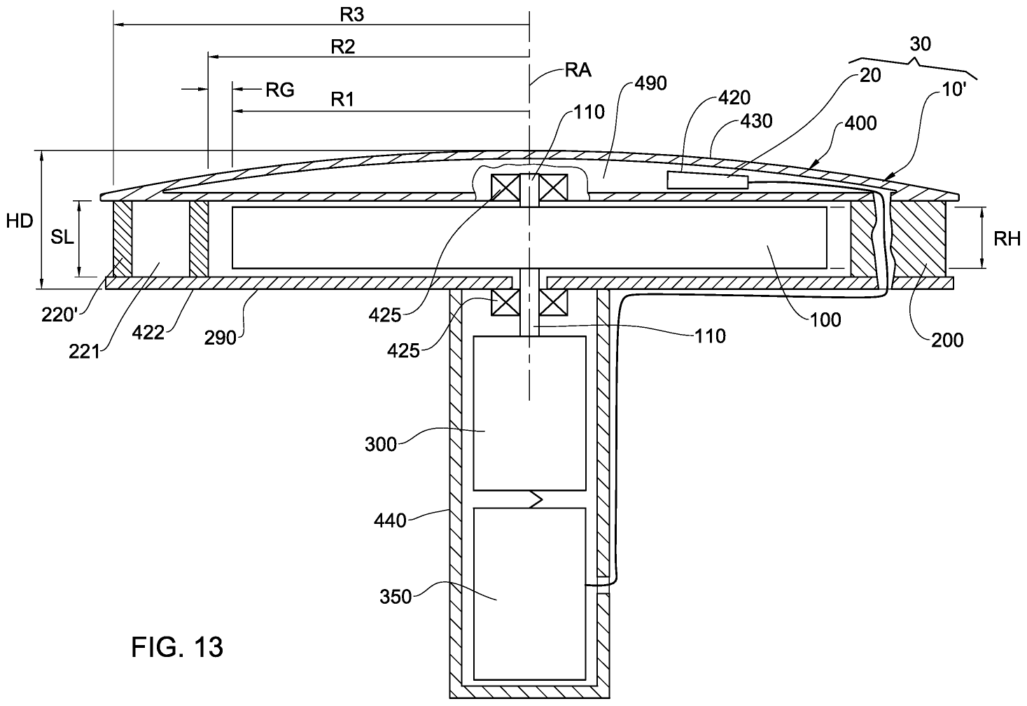

In alternative variations of this example, and referring to FIG. 13, a first example of a powered sensor (also interchangeably referred to herein as a powered sensor device), generally designated with reference numeral 30, comprises a modified device 10′, and an integral instrumentation package, for example in the form of sensor package 20. The powered sensor device 30 thus operates as a self-contained and self-powered sensor unit. In at least some examples, the instrumentation package is configured for generating and for transmitting sensor data. For example, the instrumentation package is configured for transmitting sensor data via any one of WIFI, LTE, 5G and narrowband networks.

The modified device 10′ corresponds to the device 10 as disclosed herein, mutatis mutandis, the main difference between the modified device 10′ of FIG. 13 and the device 10 of FIG. 1 being that the modified device 10′ is further configured to accommodate and operatively couple the sensor package 20 thereto.

Thus, the modified device 10′ also comprises the rotor element 100 (or variations thereof, as exemplified in FIGS. 3 to 10, for example), stator element 200, electrical generator 300, electronics and battery package 350, housing 400 having first housing part 420 and second housing part 440, as disclosed herein with respect to device 10, mutatis mutandis.

In addition, and referring again to FIG. 13, the housing 400 is further configured for accommodating the integral instrumentation package, for example in the form of sensor package 20, and for operatively coupling the sensor package 20 to the electrical generator 300 and/or to the electronics and battery package 350.

For this purpose, and it at least this example, the first housing part 420 of modified device 10′ comprises a chamber 490, which can be provided for example in the respective housing cover 430.

Furthermore, at least part of the integral instrumentation package, for example in the form of sensor package 20 is accommodated in the chamber 490, and depending on the type of sensor included in the sensor package 20, part of the sensor package 20 can project to an outside of the housing 400.

Additionally or alternatively, part or all of the integral instrumentation package, for example in the form of sensor package 20 can be accommodated in a hollow space 221 (FIG. 13) provided in at least some of the second aerodynamic elements 220 of the respective stator element 200, and optionally integrated therein.

For example, the sensor package 20 can include one or more of: an imaging camera, microwave radar devices, laser radar devices, millimeter wave radars, ultrasonic devices, passive infrared sensors, and acoustic sensors.

For example, the sensor package 20 can include one or more suitable sensors that are commercially available for use for traffic counting, people counting, people detection, traffic tracking, in-cabin people detection, animal detection, as is known in the art.

For example, such sensors can include radars, computer chips and/or modules provided by for example any one of “Texas instruments”, “NXP”, “Infineon”, “Mistral solutions USA”, “RF beam Switzerland” and so on.

Optionally, the instrumentation package can include, in addition to or instead of the sensor package, at least one signaling unit or any other suitable communication unit, which enables transmitting at least a visual signal, for example that are within the field of view of oncoming drivers. For example, the instrumentation package can include one or more LED lights, for example a plurality of lights in different shapes and/or colors, that can warn drivers for example of a hazard in real time. Such LED's can provide a continuous steady illumination, or a blinking illumination for example.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the scope of the presently disclosed subject matter as set out in the claims.

1. A device for generating electrical power, comprising a rotor element, a stator element and an electrical generator,
said rotor element comprising a rotor axis, the rotor element configured for turning about said rotor axis responsive to an airflow being applied thereto;
said stator element configured for directing the airflow from an outside of the device towards said rotor element;
said electrical generator being coupled to said rotor element and configured for being driven by rotation of the rotor element about the rotor axis to thereby generate electrical power;
wherein the device is configured for being affixed with respect to a surface such that the device projects above the surface by an external maximum vertical dimension;
the rotor axis being nominally orthogonal to the surface, at least in operation of the device; and
wherein said external maximum vertical dimension is less than 1 meter.

2. The device according to claim 1, wherein said rotor element is in the form of a single-stage rotor configuration, comprising a rotor shaft coaxial with said rotor axis, and a first plurality of first aerodynamic elements, each radially positioned with respect to the rotor axis.

3. The device according to claim 2, including one of the following:
wherein each said first aerodynamic element comprises at least one concave element having a concave surface, a concave element mouth, and a concave peak, wherein the concave peak extends in a first direction from the concave element mouth, and wherein said first direction is nominally orthogonal to said rotor axis;
wherein each said first aerodynamic element comprises at least one concave element having a concave surface, a concave element mouth, and a concave peak, wherein the concave peak extends in a first direction from the concave element mouth, and wherein said first direction is nominally orthogonal to said rotor axis, and, wherein each said concave element has a two-dimensional concave wall defining the concave surface and comprising an upper concave edge and a lower concave edge, and further comprising a nominally flat upper wall joined to said upper edge, and a nominally flat lower wall attached to said lower edge;
wherein each said first aerodynamic element comprises a slanted configuration and projecting in a general upward direction from, and joined to, a base;
wherein each said first aerodynamic element comprises a slanted configuration and projecting in a general upward direction from, and joined to, a base, and, wherein each said first aerodynamic element comprises a flat trailing edge portion including the trailing edge thereof, and a curved leading edge portion including the leading edge, each said aerodynamic element further having a respective aerodynamic element root, at which it is connected to the base, and a longitudinally opposed aerodynamic element tip, wherein the respective curved leading edge portion has generally circular transverse cross-sections, taken orthogonal to a direction parallel to the rotor axis;
wherein each said first aerodynamic element comprises a slanted configuration and projecting in a general upward direction from, and joined to, a base, and, wherein each said first aerodynamic element comprises a flat trailing edge portion including the trailing edge thereof, and a curved leading edge portion including the leading edge, each said aerodynamic element further having a respective aerodynamic element root, at which it is connected to the base, and a longitudinally opposed aerodynamic element tip, wherein the respective curved leading edge portion has generally circular transverse cross-sections, taken orthogonal to a direction parallel to the rotor axis, and, wherein for each said first aerodynamic element, each respective said transverse cross-section has a respective curvature, and wherein the curvature of the transverse cross-sections increases from the respective aerodynamic element root to the respective aerodynamic element tip.

4. The device according to claim 1, wherein said stator element comprises a second plurality of second aerodynamic elements, each said second aerodynamic element projecting from a base plate in a direction generally parallel to the rotor axis.

5. The device according to claim 4, including at least one of the following:
wherein each said second aerodynamic element is in the form of a two-dimensional aerofoil blade, having a uniform aerofoil cross-section along a length of the aerofoil blade, from a lower end of the blade to an upper end of the blade;
wherein said second aerodynamic elements are circumferentially arranged around the rotor axis RA in equally-spaced relationship with respect to one another;
each said two-dimensional aerofoil blade having a respective chord line, wherein each said chord line is set at a chord line angle to a respective radial line, each respective said radial line being an imaginary line projecting laterally along a plane of the respective aerofoil cross-section from the rotor axis and touching the respective trailing edge;
each said two-dimensional aerofoil blade having a respective chord line, wherein each said chord line is set at a chord line angle to a respective radial line, each respective said radial line being an imaginary line projecting laterally along a plane of the respective aerofoil cross-section from the rotor axis and touching the respective trailing edge, and, wherein said chord line angle is about 60° or about 90°;
each said two-dimensional aerofoil blade having a respective chord line, wherein each said chord line is set at a chord line angle to a respective radial line, each respective said radial line being an imaginary line projecting laterally along a plane of the respective aerofoil cross-section from the rotor axis and touching the respective trailing edge, and, wherein said chord line angle is between about 60° to about 90°;
wherein said aerofoil blades define a plurality of flow passages, each said flow passage being defined between two adjacent said aerofoil blades;
wherein said aerofoil blades define a plurality of flow passages, each said flow passage being defined between two adjacent said aerofoil blades, and, wherein each said flow passage has an inlet area, defined at a respective outer plane touching respective leading edges of the respective two adjacent aerofoil blades, and an exit area, defined at a respective inner plane touching respective trailing edges of the respective two adjacent aerofoil blades;
wherein said aerofoil blades define a plurality of flow passages, each said flow passage being defined between two adjacent said aerofoil blades, and, wherein each said flow passage has an inlet area, defined at a respective outer plane touching respective leading edges of the respective two adjacent aerofoil blades, and an exit area, defined at a respective inner plane touching respective trailing edges of the respective two adjacent aerofoil blades, and, wherein said inlet area is larger than said outlet area;
wherein a ratio of said second plurality to said first plurality is greater than unity;
wherein a ratio of said second plurality to said first plurality is greater than unity, and, wherein said ratio is any one of the following: 2, 3, 4, 5, 6, 7, 8, 9, 10 or greater than 10.

6. The device according to claim 1, further comprising an electronics and battery package, configured for managing and storing electrical power output of the electrical generator.

7. The device according to claim 1, comprising a housing, the housing comprising a first housing part configured for accommodating therein said rotor element and said stator element, and a second housing part configured for accommodating therein said electrical generator.

8. The device according to claim 7, including at least one of the following:
wherein said second housing part is configured for being embedded in the surface at least in operation of the device;
wherein said first housing part has a first width dimension, and the second housing part has a second width dimension, wherein the second width dimension is smaller than the first width dimension;
wherein said first housing part has a first width dimension, and the second housing part has a second width dimension, wherein the second width dimension is smaller than the first width dimension, and, wherein the first width dimension is four times larger than the second width dimension;
wherein said first housing part has a first width dimension, and the second housing part has a second width dimension, wherein the second width dimension is smaller than the first width dimension, and, wherein the second housing part has a third depth dimension, parallel to the rotor axis, the third depth dimension being greater than said second width dimension;
wherein said first housing part has a first width dimension, and the second housing part has a second width dimension, wherein the second width dimension is smaller than the first width dimension, and, wherein the second housing part has a third depth dimension, parallel to the rotor axis, the third depth dimension being greater than said second width dimension, and, wherein the third depth dimension is more than two times larger than the second width dimension;
wherein the first housing part comprises a first housing base and a first housing cover, joined together via the stator element;
wherein the rotor element is rotatably mounted with respect to the first housing part;
wherein said first housing cover is generally convex;
wherein said external maximum vertical dimension is defined by a vertical dimension of said first housing part;
wherein the device is configured for being anchored to the surface, such that only the first housing part projects above the surface;
the second housing part being configured for being fully embedded in the surface at least in operation of the device, while concurrently the first housing part remains above the surface.

9. The device according to claim 1, wherein said external maximum vertical dimension is less than at least one of the following: 0.9 m; 0.8 m; 0.7 m; 0.6 m; 0.5 m; 0.45 m; 0.4 m; 0.35 m; 0.30 m; 0.25 m; 0.20 m; 0.15 m; 0.10 m; 0.05 m; 0.04 m.

10. The device according to claim 1, configured for being affixed to a road surface by being embedded in the road surface or in a respective subgrade, or by being attached to the surface of a roadway.

11. The device according to claim 1, configured for being affixed to the surface such that the external maximum vertical dimension is such as to enable air flows close to the surface to enter the device via the stator element and cause the rotor element to rotate about the rotor axis, thereby causing the electrical generator to generate electrical power.

12. A system comprising:
at least one device as defined in claim 1;
at least one external electrical load electrically coupled to said at least one device, each said device configured for providing electrical power to said at least one external electrical load.

13. The system according to claim 12, including at least one of the following:
wherein the external electrical load is in the form of, or includes, an electrical component that consumes electrical power or a portion of an electrical circuit that consumes electrical power;
wherein at least one said electrical load includes at least one road sensor;
wherein at least one said electrical load includes at least one road sensor, and, wherein at least one said sensor is in the form of an in-roadway sensor or an over-roadway sensor;
wherein at least one said electrical load includes at least one road sensor, and, wherein at least one said road sensor is any one of an inductive-loop sensor, magnetic detector, magnetometer, imaging cameras, microwave radar devices, laser radar devices, millimeter wave radars, ultrasonic devices, passive infrared sensors, and acoustic sensors.

14. A powered sensor, comprising:
a device as defined in claim 1;
an integral instrumentation package, accommodated in the device and operatively coupled to the device.

15. The powered sensor according to claim 14, including at least one of the following:
wherein the housing is configured for accommodating the instrumentation package, and for operatively coupling the instrumentation package to the electrical generator and/or to the electronics and battery package;
wherein the first housing part comprises a chamber for accommodating at least a part of the instrumentation package;
wherein part of the instrumentation package can project to an outside of the housing;
wherein the instrumentation package includes a sensor package;
wherein the instrumentation package includes a sensor package, and, wherein the sensor package comprises one or more of: an imaging camera, microwave radar devices, laser radar devices, millimeter wave radars, ultrasonic devices, passive infrared sensors, and acoustic sensors.

16. The powered sensor according to claim 14, including one of the following:
wherein the instrumentation package includes at least one signaling unit configured for selectively transmitting at least a visual signal;
wherein the instrumentation package includes at least one signaling unit configured for selectively transmitting at least a visual signal, and, wherein the at least one signaling unit is configured for selectively transmitting said at least a visual signal within a field of view of oncoming drivers;
wherein the instrumentation package includes at least one signaling unit configured for selectively transmitting at least a visual signal, and, wherein said at least one signaling unit comprises at least one LED light;
wherein the instrumentation package includes at least one signaling unit configured for selectively transmitting at least a visual signal, and, wherein the at least one signaling unit is configured for selectively transmitting said at least a visual signal within a field of view of oncoming drivers, and, wherein said at least one signaling unit comprises at least one LED light.

17. The powered sensor according to claim 16, wherein said at least one signaling unit is configured for warning drivers of a hazard in real time.

18. The powered sensor according to claim 14, including one of:
wherein the instrumentation package is configured for generating and for transmitting sensor data;
wherein the instrumentation package is configured for generating and for transmitting sensor, and, wherein the instrumentation package is configured for transmitting sensor data via any one of WIFI, LTE, 5G and narrowband networks.

19. A method of providing an electrical power source to an external load, comprising:
(a) providing a device as defined in claim 1;
(b) affixing the device with respect to a surface such that no part of the device projects above the surface by more than said external maximum vertical dimension;
(c) electrically coupling the device to the external load;
(d) the device being affixed to the surface at a location sufficiently close to where road vehicles are expected to be travelling, such that the passage of the road vehicles close to the device causes a disturbance in the air which in turn induces an airflow into the device via the respective stator element to thereby turn the rotor element and thereby enable the electrical generator to generate said electrical power and to provide the electrical power to the external load.

20. A method of providing powered sensor, comprising:
(a) providing a powered sensor as defined in claim 14;
(b) affixing the powered sensor with respect to a surface such that no part of the device projects above the surface by more than said external maximum vertical dimension;
(c) affixing the powered sensor to the surface at a location sufficiently close to where road vehicles are expected to be travelling, such that the passage of the road vehicles close to the powered sensor causes a disturbance in the air which in turn induces an airflow into the powered sensor via the respective stator element to thereby turn the rotor element and thereby enable the electrical generator to generate said electrical power and to provide the electrical power to the powered sensor.
